(19) United States
(12) Patent Application Publication
(10) Pub. No.: US 2004/0164443 A1
(43) Pub. Date: Aug. 26, 2004

(54) Process for granulating polyarylene sulfide based-resin

(75) Inventor: Yoshinari Koyama, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: IDEMITSU PETROCHEMICAL CO., LTD., Tokyo (JP); PETROLEUM ENERGY CENTER, Tokyo (JP)

(21) Appl. No.: 10/368,568

(22) Filed: Feb. 20, 2003

(51) Int. Cl. B29C 47/00

(52) U.S. Cl. 264/142; 264/143

(57) ABSTRACT

There is disclosed a process for granulating a polyarylene sulfide-based resin which comprises extruding a molten polyarylene sulfide-based resin with an extruder through a die nozzle, thereafter taking off the resin in cooling water at a temperature in the range of 5 to 60° C. which flows down on a prescribed inclined surface, and cutting off the resin and pelletizing the same at a prescribed position on the downstream region. It is made possible by the above process to efficiently steadily produce micro-pellets and amorphous pellets of the polyarylene sulfide-based resin. Furthermore, in the case of preparing the compound of the pellets by compositing with a filler such as calcium carbonate, the stability of an extruder can be assured by the specific resin pellets.

### BACKGROUND OF THE INVENTION

1. Field of the Invention.

The present invention relates to a process for granulating a polyarylene sulfide-based resin. More particularly, it pertains to a process for pelletizing a polyarylene sulfide-based resin.

2. Description of the Related Arts

A polyarylene sulfide-based resin has heretofore been employed in many cases as a compound by blending with an inorganic filler such as glass fiber to composite the resin because of its low degree of polymerization, excessively high fluidity and the resulting difficulty in molding processing. Under such circumstances, the polyarylene sulfide-based resin in the form of powder for compounding has been employed in the majority of instances and accordingly, an investigation has not seriously be made on the so-called pelletization of the polyarylene sulfide-based resin into the form of go-ishi (circular pebbles used for the Japanese game of “go”), cylinder or sphere.

However as a development has been made on simple compounding equipment in recent years, it has been desired to pelletize a single component of the polyarylene sulfide-based resin, thereby giving rise to necessity to investigate a process for granulating a polyarylene sulfide-based resin. For instance there is available as such a granulating process, an underwater cutting process or hot cutting process referred to Japanese Patent Application Laid-Open No. 210932/2000 (Heisei 12).

However, when an attempt is made to produce micro-pellets each having a diameter of about one mm by any of the above-mentioned processes, for instance, in the case of the underwater cutting process, the die nozzle diameter is required to be smaller, thereby bringing about the problem of the die nozzle clogging and the resulting difficulty in continuous operation. In the case of the hot cutting process, when the die nozzle diameter is made smaller, there is brought about the problem of difficulty in resin cutting.

On the other hand, in the case of producing a compound of a polyarylene sulfide-based resin by mixing the aforesaid resin with a filler such as calcium carbonate, amorphous polyarylene sulfide-based resin is easier in mixing than crystalline polyarylene sulfide-based resin and accordingly, it has been desired to develop a pelletized amorphous polyarylene sulfide-based resin. Nevertheless, when an attempt is made to produce such amorphous pelletized resin, in the case of the underwater cutting process, the die nozzle clogging is caused by cooling water coming in direct contact with the die surface. In order to prevent such clogging, the nozzle diameter needs to be enlarged. As a result, the pellets thus formed are large-sized, thereby making it difficult to produce micro-pellets each having a diameter of about one mm as mentioned hereinbefore. Moreover, although the surface layer of the pellets thus produced is amorphous, most portions thereof are crystalline. Likewise in the case of the hot cutting process, although the surface layer of the pellets thus produced is amorphous, most portions thereof become crystalline. In this case, when the die nozzle diameter is made smaller, there is brought about the problem of difficulty in resin cutting as mentioned hereinbefore.

### SUMMARY OF THE INVENTION

The present invention has been made in the light of the above-mentioned subject.

Thus, a general object of the present invention is to provide a process for granulating a polyarylene sulfide-based resin which process is capable of producing micro-pellets and amorphous pellets of a polyarylene sulfide-based resin in high efficiency and in a stable manner.

Another object of the present invention is to provide a process for granulating a polyarylene sulfide-based resin which process is capable of assuring the stability of an extruder in the case of preparing a compound composed of said resin and a filler such as calcium carbonate.

Other objects of the present invention will become obvious from the text of the specification hereinafter disclosed.

In the light of the above-mentioned subject, intensive extensive research and investigation were accumulated by the present inventors in order to achieve the objects. As a result, it has been found that the objects of the present invention can be achieved by extruding a polyarylene sulfide-based resin through a die nozzle of an extruder, thereafter taking off said resin and allowing the same to flow down in cooling water which flows down at a prescribed velocity on a prescribed inclined surface, and cutting off the resin at a prescribed position on the downstream region so that objective resin pellets are obtained. The present invention has been accomplished on the basis of the foregoing findings and information.

Specifically, the present invention provides a process for granulating a polyarylene sulfide-based resin which comprises extruding a molten polyarylene sulfide-based resin with an extruder through a die nozzle, thereafter taking off said resin in cooling water at a temperature in the range of 5 to 60° C. which flows down on a prescribed inclined surface, and cutting off the resin and pelletizing the same at a prescribed position on the downstream region. In particular, the present invention is characterized in that the above-mentioned granulation process is carried out by the use of a underwater strand pelletizer.

### BRIEF DESCRIPTION OF DRAWING

FIG. 1 is a schematic perspective view schematically showing one example of a pelletizer unit which carries out a granulation process according to the present invention.

### DESCRIPTION OF THE PREFERRED EMBODIMENTS

{Polyarylene Sulfide-based Resin}

The polyarylene sulfide-based resin which is to be used in the present invention is a polymer having at least 70 mole % of the repeating unit represented by [—Ar—S—] wherein Ar is an arylene group and S is a sulfur atom. A typical example includes an polyarylene sulfide having at least 70 mole % of the repeating unit represented by the following general formula (I):

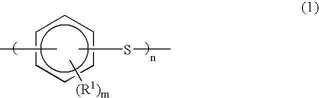

wherein R₁ is a substituent selected from an alkyl group having at most 6 carbon atoms, an alkoxy group, a phenyl group, a carboxylic acid or a metal salt thereof, an amino group, a nitro group and a halogen atom such as a fluorine atom, chlorine atom and bromine atom; m is an integer from 0 to 4; and m denotes degree of polymerization and is in the range of 10 to 200.

The polyarylene sulfide, when having less than 70 mole % of the above-describved repeating unit, sometimes brings about a less content of inherent crystalline components that are the characteristics of a crystalline polymer, and also insufficiency in mechanical strength.

As the polyarylene sulfide, there is usable a copolymer in addition to a homopolymer. Examples of constituting unit of the copolymer include meta-phenylene sulfide unit; ortho-phenylene sulfide unit; p, p′-diphenyleneketone sulfide unit; p, p′-diphenylenesulfone sulfide unit; p, p′-biphenylene sulfide unit; p, p′-di-phenylenemethylene sulfide unit; p, p′-diphenylenecumenyl sulfide unit; and naphthylene sulfide unit.

The molecular structure of the polyarylene sulfide may be any of linear structure, branched structure and crosslinked structure. That is to say, as the polyarylene sulfide-based resin according to the present invention, there is usable in addition to the polyarylene sulfide having a substantially linear structure, a branched or crosslinked polyarylene sulfide in which a small amount of monomer having at least three functional groups as a part of monomers is polymerized and a blended polymer in which the polyarylene sulfide just cited is blended with the foregoing substantially linear polymer.

Moreover, as a polyarylene sulfide-based resin to be used in the present invention, there is also usable a polyarylene sulfide-based polymer in which its melt viscosity is increased so as to improve its moldability by oxidative crosslinking or thermal crosslinking of the polymer having a relatively low molecular weight and substantially linear structure. The above-mentioned polyarylene sulfide-based resin can be produced by a well known process, for instance, by subjecting a dihalogenated aromatic compound and a sulfur source to polycondensation reaction in an organic polar solvent, cleaning the resultant product and drying the same.

The polyarylene sulfide-based resin to be used in the present invention has an inherent viscosity ηᵢₕₙ [dl/g] in the range of 0.05 to 0.45 dl/g, preferably 0.1 to 0.4 dl/g, more preferably 0.12 to 0.35 dl/g. The inherent viscosity ηᵢₕₙ [dl/g], when being higher than 0.45 dl/g, sometimes gives rise to lowering in fluidity at the time of extrusion molding, thereby causing difficulty in granulation, whereas the inherent viscosity ηᵢₕₙ [dl/g], when being lower than 0.05 dl/g, sometimes leads to difficulty in taking off the resultant resin in a underwater strand pelletizer.

The inherent viscosity ηᵢₕₙ [dl/g] is determined by dissolving a polymer sample in an amount of 0.04 g±0.001 g in 10 milliliter of α-chloronaphthalene at 235° C. within 15 minutes, measuring the viscosity of the resultant solution of the polymer obtained in a thermostat at 200° C. and also measuring the viscosity of α-chloronaphthalene in which the polymer is not dissolved, and calculating by the following formula:

ηᵢₕₙ=In (relative viscosity)/polymer concentration [dl/g]

{Process for Granulating the Polyarylene Sulfide-based Resin}

Since the polyarylene sulfide-based resin which is the object of the granulation process according to the present invention is brittle because of its insufficiency in viscosity even if plasticized, it is difficult in molding from ordinary strand. For this reason there is adopted a granulation process which comprises extruding a molten polyarylene sulfide-based resin with an extruder through a die nozzle, thereafter taking off said resin in cooling water at a temperature in the range of 5 to 60° C. which flows down on a prescribed inclined surface, and cutting off the resin and pelletizing the same at a prescribed position on the downstream region.

Specifically in the granulation process according to the present invention, the molten polyarylene sulfide-based resin is extruded with an extruder through a die nozzle at a die temperature in the range of 280 to 350° C., preferably 290 to 340° C., more preferably 300 to 320° C., and then is taken off in cooling water at a temperature in the range of 5 to 60° C., preferably 10 to 40° C. The die temperature, when being lower than 280° C., sometimes results in unstable fluidity of the resin at the outlet of the die and incapability of obtaining stable pellets, whereas the die temperature, when being higher than 350° C., sometimes causes initiation of decomposition of the resin in part, thereby giving rise to a problem of burning or yellowing. The cooling water temperature, when being higher than 60° C., brings about insufficiency in resin cooling, difficulty in resin cutting off and pellet crystallization and what is more, exerts adverse influence upon the stability of an extruder at the time of compositing with a filler and the like.

The cooling water which takes off the above-mentioned extruded resin flows down on a prescribed inclined surface at a prescribed flow velocity. The resin which has been extruded through the die is taken off with the aforesaid cooling water, is allowed to flow down on the aforesaid inclined surface according to the prescribed flow velocity, and is cut off with a cutting means which has been installed at a prescribed position on the downstream region, so that it is pelletized.

The flow velocity of the cooling water on the above-mentioned inclined surface which transports the polyarylene sulfide-based resin is not specifically limited, but is preferably in the range of 60 to 250 meter/minute from the viewpoints of miniaturization of pellets and productivity of the resin. The angle of inclination of the inclined surface can be properly optionally adjusted in accordance with the purpose of use thereof in relation to the flow velocity as described hereinabove.

The process for granulating a polyarylene sulfide-based resin according to the present invention can be put into practice by the use of a unit which is specifically constituted of an extruder, a die, a underwater strand pelletizer, a screen filter, a dryer, a vibration type screen and the like.

The underwater strand pelletizer is composed of a diverter-sluicer, a water slide, a dehydration zone, a pelletizer, a pellet cooling chute and the like.

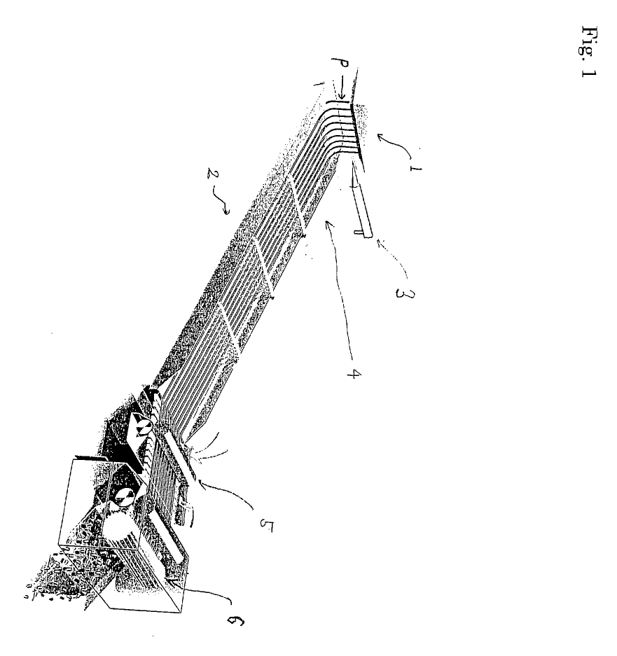

FIG. 1 is a schematic perspective view schematically showing one example of a underwater strand pelletizer unit which carries out a granulation process according to the present invention. According to FIG. 1, a polyarylene sulfide-based resin P which has been molten and extruded with an extruder 1 through a die and a nozzle is introduced in a underwater strand pelletizer 2. Specifically the aforesaid resin P is taken off and allowed to flow down in cooling water which is supplied from a cooling water supply means in the unit and is allowed to flow down on a water slide 4 at a prescribed flow velocity. The resin P, after being dehydrated in a dehydration zone 5 on the downstream region, is conveyed to a pelletizer 6, where it is cut off so as to be pelletized into a prescribed size and thereafter is sent to a pellet cooling chute.

The pellets thus cut off are transferred to a filter such as a screen filter along with a stream of water, are sent to a centrifugal separator, a hot-air circulation type dryer and the like so as to be dehydrated and dried, and subsequently are introduced in a product packaging step as the final stage. The aforesaid filter may be installed either on the upstream side or the downstream side of the pelletizer 6.

According to the granulating process of the present invention, it is made possible to steadily produce resin pellets in the shape of column, especially micro-pellets measuring 0.5 to 1.5 mm in size. In addition, the resultant pellets have high quality with less abnormal products in external appearance or shape and less jointed pellets. Moreover, the working effects accompanying the use of cooling water include favorable capability of removing residual alkali metal salts (sodium chloride, lithium chloride and the like) in the polyarylene sulfide-based resin.

In summarizing the working effects and advantages of the present invention, the process for granulating a polyarylene sulfide-based resin makes it possible to efficiently and steadily produce micro-pellets and amorphous pellets of the polyarylene sulfide-based resin. Further the pellets obtained according to the granulating process of the present invention are well suited for use in the case of preparing the compound of the pellets by compositing with a filler such as calcium carbonate and zinc oxide, since the stability of an extruder can be assured by the specific resin pellets.

In what follows, the present invention will be described in more detail with reference to comparative examples and working examples, which however shall never limit the present invention thereto.

### EXAMPLE 1

{Preparation of Polyarylene Sulfide-based Resin}

Into a 50 liter polymerization vessel were placed 50 mol (2297 g) of lithium sulfide, 50 mol (7350 g) of p-dichlorobenzene, 2.5 mol (105 g) of lithium hydroxide hydrate, 25 mol (450 g) of water and 21 liter of N-methyl-2-pyrrolidone (hereinafter referred to as “NMP”) to proceed with reaction at 260° C. for 3 hours. The reactants were allowed to cool down to 100° C. and the liquid phase was separated off to obtain a precipitated polymer, which was washed twice with cold water. The washed polymer was placed in the 50 liter polymerization vessel, to which were added 25 liter of NMP and 150 milliliter (mL) of acetic acid, and the resultant mixture was washed at 150° C. for one hour. After allowing the mixture to cool, the polymer in solid form was washed once with cold water. Thereafter the polymer was dried at 120° C. for 24 hours by means of a hot air dryer, and further was subjected to vacuum drying at 120° C. for 24 hours. The dried polymer thus obtained was a linear polyarylene sulfide-based resin which had an inherent viscosity ηᵢₕₙ [dl/g] of 0.23 dl/g and a residual lithium amount in the polymer being 100 ppm.

{Granulation of Polyarylene Sulfide-based Resin}

The polyarylene sulfide-based resin in the form of powder obtained through the above-mentioned polymerization, washing and drying was fed to an extruder (manufactured by Japan Steel Works, Ltd. under the trade name “TEX30 α-42B-5V”), and extruded through a nozzle having a hole of 5 mm in diameter at a die temperature of 320° C., a die outlet temperature of 320° C. at an extruding rate of 36 kg /hour. The resultant extrudate was taken off with a underwater strand pelletizer (manufactured by HANJIN Co. Ltd. under the trade name “HJCH1”) at a flow down velocity of cooling water at 20° C. being 180 m/min, so that the resin was pelletized. The pellets thus obtained were each in the shape of column having a diameter of 1.8 mm and a length of 2.5 mm. The crystalline structure thereof was examined by the use of differential scanning calorimeter (manufactured by PERKIN-ELMER Co. Ltd. under the trade name “DSC-7”). As a result, the pellets had amorphous structure and crystallinity of 0%.

### EXAMPLE 2

The procedure in Example 1 was repeated to granulate the resin and prepare pellets by the use of the polyarylene sulfide-based resin same as in Example 1 except that use was made of a nozzle having 3 holes of each 3 mm in diameter in place of 5 mm.

The pellets thus obtained were each in the shape of column having a diameter of 1.0 mm and a length of 1.5 mm. The crystalline structure thereof was examined by the use of differential scanning calorimeter (manufactured by PERKIN-ELMER Co. Ltd. under the trade name “DSC-7”). As a result, the pellets had amorphous structure and crystallinity of 0%.

### COMPARATIVE EXAMPLE 1

The polyarylene sulfide-based resin same as that prepared in Example 1 was fed to an underwater cutting apparatus composed of an extruder (manufactured by Japan Steel Works, Ltd. under the trade name “TEX44XCT-38.5BW-4V”) and an underwater cutting pelletizer (underwater cutting apparatus directly coupled and driven with a horizontal cutter, manufactured by Japan Steel Works, Ltd.), so that the resin was pelletized at a die temperature of 320° C., a die outlet temperature of 320° C. at a cooling water temperature of 80° C.

The pellets thus obtained were each in the shape of go-ishi (circular pebbles used for the Japanese game of “go”) having a diameter of 3.0 mm and a length of 1.0 mm. The crystalline structure thereof was examined by the use of differential scanning calorimeter (manufactured by PERKIN-ELMER Co. Ltd. under the trade name “DSC-7”). As a result, the pellets had crystalline structure and crystallinity of 25%.

### COMPARATIVE EXAMPLE 2

The polyarylene sulfide-based resin same as that prepared in Example 1 was fed to an aerial hot cutting pelletizer composed of an extruder (manufactured by Japan Steel Works, Ltd. under the trade name “TEX44XCT-38.5BW-4V”) and an aerial cutting pelletizing apparatus (aerial center hot cutting apparatus, manufactured by Japan Steel Works, Ltd. under the trade name “CHC-1”), in which the resin was extruded into air at a die temperature of 320° C., simultaneously was cut at nozzle outlet at a die outlet temperature of 320° C. and thereafter was cooled with cooling water at a temperature of 30° C., so that the resin was palletized.

The pellets thus obtained were each in the shape of go-ishi (circular pebbles used for the Japanese game of “go”) having a diameter of 3.0 mm and a length of 1.0 mm. The crystalline structure thereof was examined by the use of differential scanning calorimeter (manufactured by PERKIN-ELMER Co. Ltd. under the trade name “DSC-7”). As a result, the pellets had crystalline structure and crystallinity of 30%.

The pellets which had been obtained in the above-mentioned Examples and Comparative Examples were composited with calcium carbonate under the conditions described hereunder so as to examine the operational properties. The results thereof along with those in the Examples and Comparative Examples are collectively given in Table 1.

{Conditions of Compositing Test}

Twin screw extruder: manufactured by Toshiba Machine Co. Ltd. under the trade name “TEM 37BS”

Polyarylene sulfide resin:calcium carbonate (ratio by weight) =1:1

Charging rate: 7 kg/hour

Number of revolutions: 200 rpm

TABLE 1

| | | | | Operational |
|---|---|---|---|---|
| | Granulating | Pellets | | properties |
| | Process | Size (mm) | Crystal state | upon compositing |
| Example 1 | underwater | diameter: 1.8 | amorphous | no variation |
| | strand | length: 2.5 | | |
| | pelletizer | | | |
| Example 2 | underwater | diameter: 1.5 | amorphous | no variation |
| | strand | length: 1.0 | | |
| | pelletizer | | | |
| Comp'tive | underwater | diameter: 3.0 | crystalline | Motor ampere |
| Example 1 | cutting type | length: 1.0 | | varied Abnormal |
| | | | | noise produced |
| | | | | from extruder |
| Comp'tive | hot cutting | diameter: 3.0 | crystalline | Motor ampere |
| Example 2 | type | length: 1.0 | | varied Abnormal |
| | | | | noise produced |
| | | | | from extruder |

{Remarks} Comp'tive: Comparative

What is claimed is:

1. A process for granulating a polyarylene sulfide-based resin which comprises extruding a molten polyarylene sulfide-based resin with an extruder through a die nozzle, thereafter taking off said resin in cooling water at a temperature in the range of 5 to 60° C. which flows down on a prescribed inclined surface, and cutting off the resin and pelletizing the same at a prescribed position on the downstream region.

2. The process for granulating a polyarylene sulfide-based resin according to claim 1, wherein the flow down velocity of the cooling water is in the range of 60 to 250 meter/minute.

3. The process for granulating a polyarylene sulfide-based resin according to claim 1, wherein the pelletization of said resin is effected by means of a underwater strand pelletizer.

4. The process for granulating a polyarylene sulfide-based resin according to claim 1, wherein the granulated polyarylene sulfide-based resin is amorphous.

5. The process for granulating a polyarylene sulfide-based resin according to claim 1, wherein the granulated polyarylene sulfide-based resin is usable for compositing with a filler by means of an extruder.
